(19) United States
(12) Patent Application Publication
(10) Pub. No.: US 2005/0260975 A1
(43) Pub. Date: Nov. 24, 2005

(54) Telecommunications system and method for providing an automatic notification of availability of a communication device to establish a telephone call

(76) Inventors: Christopher Yao Wen Chen, San Francisco, CA (US); Victor Zhiping Zhuo, San Francisco, CA (US)

Correspondence Address: WILSON & HAM, 2530 BERRYESSA ROAD, PMB: 348, SAN JOSE, CA, 95132, US

(21) Appl. No.: 10/848,954

(22) Filed: May 19, 2004

(51) Int. Cl. H04B 1/38; H04M 1/00

(52) U.S. Cl. 455/415; 455/567; 455/426.1

(57) ABSTRACT

A telecommunications system and method for providing a notification of the availability of a target communication device to receive a call monitors the target communication device to effectuate a generation of a notification signal at a calling communication device when the target communication device is available to receive a call. The monitoring of the target communication device may involve receiving the latest status information of the target communication device from a network, such as a Voice over Internet Protocol (VoIP) network or a cellular telephone network.

### FIELD OF THE INVENTION

The invention relates generally to telecommunications systems, and more particularly to a telecommunications system using a network that requires communication devices to be logged on to make and receive telephone calls.

### BACKGROUND OF THE INVENTION

Cellular and Voice over Internet Protocol (VoIP) technologies offer many advantages over the traditional plain old telephone service (POTS). A significant advantage of the cellular technology is the wireless connection provided by the cellular technology, which allows a user to make and receive telephone calls from virtually anywhere in the world. Since cell phones are small enough to carry, a cell phone user can usually be reached by calling the cell phone of that user. A significant advantage of the VoIP technology is the lack of fee associated with telephone calls made through the Internet using the VoIP technology, except the fee for connecting to the Internet. Thus, long distance calls including international calls can be made for essentially free of charge.

Unlike traditional telephones connected to the Public Switched Telephone Network (PSTN) for POTS, the cellular and VoIP technologies require the cell phone or the VoIP telephone (e.g., Internet-connected computer with a VoIP application) to be logged on to the respective network to make and receive telephone calls. Consequently, if a cell phone is not turned on and logged on to the associated cellular network, a telephone call cannot be made to that cell phone. Similarly, if a VoIP telephone is not logged on to a VoIP network, a telephone call cannot be made to that VoIP telephone. Therefore, to establish a telephone call to a cell phone user or a VoIP user, a calling party has to repeatedly attempt make a telephone call until the receiving party is available to receive the telephone call, i.e., the receiving party has turned on the cell phone or has logged on to the VoIP network.

In view of this concern, there is a need for a telecommunications system and method for establishing telephone calls that allows a calling party to know when a particular receiving party is available to receive a telephone call.

### SUMMARY OF THE INVENTION

A telecommunications system and method for providing a notification of the availability of a target communication device to receive a call monitors the target communication device to effectuate a generation of a notification signal at a calling communication device when the target communication device is available to receive a call. The monitoring of the target communication device may involve receiving the latest status information of the target communication device from a network, such as a Voice over Internet Protocol (VoIP) network or a cellular telephone network.

A telecommunications system in accordance with an embodiment of the invention includes a calling communication device operatively connected to a network to transmit and receive signals through said network, and an automatic notification module operatively connected to the network to monitor a target communication devices operatively connected to the network to determine when the target communication device is available to establish a call. The automatic notification module is configured to effectuate generation of a notification signal at the calling communication device when the target communication device is available to establish said call.

A method for proving a notification of an availability of a target communication device to establish a call includes determining whether the target communication device is available to establish the call from a calling communication device, monitoring the target communication device to determine when the target communication device is available to establish the call, and effectuating generation of a notification signal at the calling communication device when the target communication device is available to establish the call.

An embodiment of the invention includes a program storage medium, readable by a computer, tangibly embodying a program of instructions executable by the computer to perform the method steps for proving a notification of an availability of a target communication device to establish a call.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1A is a diagram of a telecommunications system in accordance with an embodiment of the invention.

FIG. 1B is a diagram of a communication device of the telecommunications system of FIG. 1A in accordance with an embodiment of the invention.

FIG. 2 is a block diagram of the components of a call routing device included in the communication device of FIG. 1B in accordance with an embodiment of the invention.

FIGS. 3A and 3B are block diagrams of a switching unit of the call routing device of FIG. 2, illustrating activated and deactivated states of one of the relays of the switching unit.

FIGS. 4A and 4B are also block diagrams of the switching unit of the call routing device of FIG. 2, illustrating activated and deactivated states of the other relay of the switching unit.

FIG. 5 is also a block diagram of the switching unit of the call routing device of FIG. 2, illustrating the default state for the switching unit.

FIG. 6 is a block diagram of a computer of the communication device of FIG. 1B in accordance with an embodiment of the invention.

FIG. 7 is a flow diagram of a process for making a standard PSTN call using the communication device of FIG. 1B in accordance with an embodiment of the invention.

FIG. 8 is a flow diagram of a process for making a VoIP call using the communication device of FIG. 1B in accordance with an embodiment of the invention.

FIG. 9A is a flow diagram of a process for receiving a PSTN call at the communication device of FIG. 1B when the device is not currently being used for a VoIP call in accordance with an embodiment of the invention.

FIG. 9B is a flow diagram of a process for receiving a PSTN call at the communication device of FIG. 1B when the device is currently being used for a VoIP call in accordance with an embodiment of the invention.

FIG. 10A is a flow diagram of a process for receiving a VoIP call at the communication device of FIG. 1B when the device is not currently being used for a PSTN call in accordance with an embodiment of the invention.

FIG. 10B is a flow diagram of a process for receiving a VoIP call at the communication device of FIG. 1B when the device is currently being used for a PSTN call in accordance with an embodiment of the invention.

FIGS. 11A and 11B are flow diagrams of a process for providing an automatic notification in accordance with an embodiment of the invention

FIG. 12 is a diagram of a cellular telecommunications system in accordance with an embodiment of the invention.

FIG. 13 is a flow diagram of a method for providing a notification of an availability of a target communication device to establish a call in accordance with an embodiment of the invention.

### DETAILED DESCRIPTION

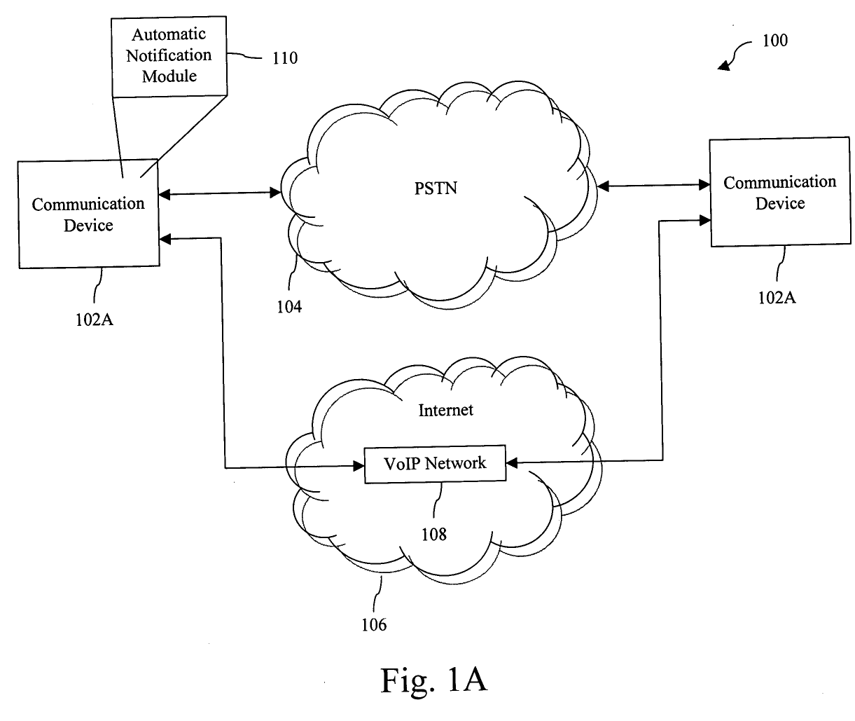

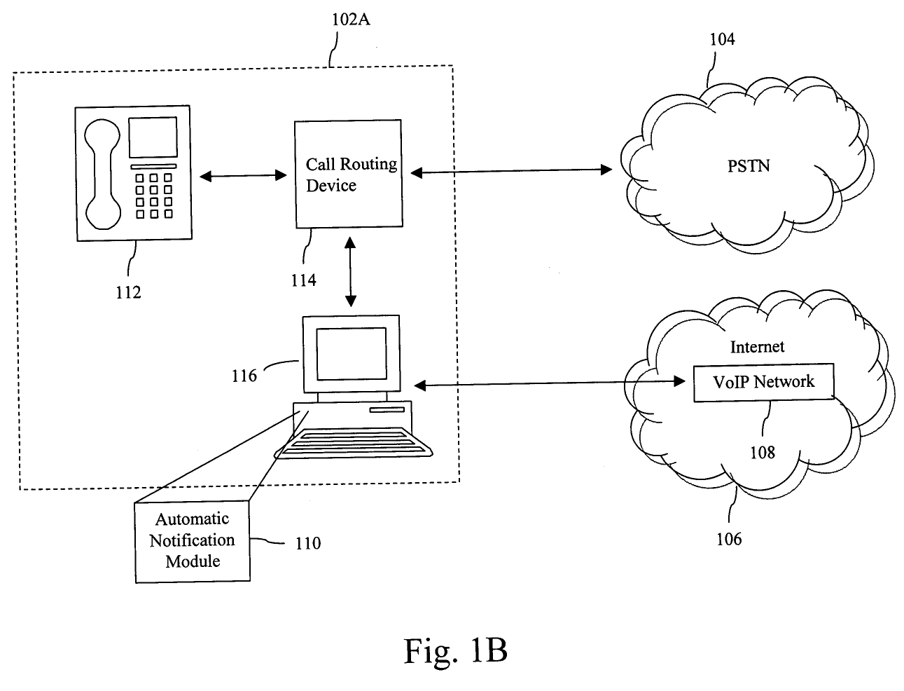

With reference to FIG. 1A, a telecommunications system 100 in accordance with an embodiment of the invention is described. As described in more detail below, the telecommunications system 100 allows a first party to be automatically notified when a desired second party is available to receive a telephone call from the first party. Thus, using the telecommunications system 100, the first party does not have to repeatedly attempt to establish a telephone call to the second party when the second party is not available to receive a telephone call from the first party.

As shown in FIG. 1A, the telecommunications system 100 includes communication devices 102A and 102B that are connected to both a circuit switching network 104 and a packet switching network 106. As an example, the circuit switching network 104 and the packet switching network 106 are illustrated in FIG. 1A as the Public Switching Telephone Network (PSTN) and the Internet, respectively. However, the packet switching network 106 can be another type of packet switching network, such as a Local Access Network (LAN) or a Wide Area Network (WAN). Alternatively, the packet switching network 106 may be a combination of same or different packet switching networks. Similarly, the circuit switching network 104 may be another type of circuit switching network or a combination of circuit switching networks. Since the communication devices 102A and 102B are connected to both the PSTN 104 and the Internet 106, a user of the communication device 102A or 102B can selectively make a traditional telephone call, referred to herein as a PSTN call, through the PSTN 104 or a Voice over Internet Protocol (VoIP) call through the Internet 106. As described in more detail below, in an embodiment, the automatic notification feature of the telecommunications system 100 is used only for the VoIP application. Thus, the communication devices 102A and 102B need only be connected to the Internet 106 to be able to use the automatic notification feature provided by the telecommunications system 100. Although only the two communication devices 102A and 102B are shown in FIG. 1A, the telecommunications system 100 may include more communication devices.

The telecommunications system 100 further includes a VoIP network 108 and at least one automatic notification module 110. The VoIP network 108 enables VoIP calls to be made through the Internet 106 between the communication devices 102A and 102B when the device are logged on to the VoIP network. In an embodiment, the VoIP network 108 is an instant messaging network, such as those provided by MSN or YAHOO. However, the VoIP network 108 may be any peer-to-peer network or any existing VoIP network that can be used for VoIP calls. The VoIP network 108 maintains information on the status of the communication devices 102A and 102B. This status information for each communication device may include whether the communication device is logged on to the VoIP network 108, whether the communication device has been manually set to “invisible” (i.e., the device has been manually set to be unavailable) and whether the communication device is busy (the device is currently being used for a VoIP call).

The automatic notification module 110 operates to provide availability notifications. In one embodiment, the automatic notification module 110 is incorporated into a communication device, such as the communication device 102A, as illustrated in FIG. 1A. Additional automatic notification modules may be incorporated into other communication devices of the telecommunications system 100, such as the communication device 102B. In this embodiment, the automatic notification module 110 provides availability notifications to the communication device into which the automatic notification module is incorporated. In another embodiment, the automatic notification module 110 is incorporated into the VoIP network 108. In this embodiment, the automatic notification module 110 may provide availability notifications to multiple communication devices that are logged on to the VoIP network 108.

The automatic notification module 110 is configured to determine whether one or more target communication devices of the telecommunications system 100 are available to receive VoIP calls. If a target communication device is not available and if a request is made from a calling communication device with the automatic notification module 110, such as the communication device 102A, the automatic notification module is able to monitor the currently unavailable communication device. When a monitored communication device becomes available, the automatic notification module 100 notifies the calling communication device that made the request and provides an option to the calling communication device whether to connect to the now-available communication device.

Turning now to FIG. 1B, the communication device 102A of the telecommunications system 100 in accordance with an embodiment of the invention is shown. The communication device 102A is configured to manage telephone calls via the PSTN 104 and/or the Internet 106. Using the communication device 102A, telephone calls can be made and received through the PSTN 104 and/or the Internet 106 via the VoIP network 108. The communication device 102A can also automatically initiate a telephone call through the PSTN 104 or the Internet 166. In addition, a telephone call received at the communication device 102A through the PSTN 104 can be connected to a separate telephone call through the Internet 106 at the premises of a telephone line subscriber. Thus, the communication device 102A enables advance call routing/switching features, such as conferencing and call forwarding, using telephone calls made through the two different networks 104 and 106. In addition, since the communication device 102A is connected to the two different networks 104 and 106 at the premises of a telephone line subscriber, these advance telephone features do not require the services of telephone companies. Furthermore, the communication device 102A enables other telephone features, such as automatic call denial (form of call screening), voicemail and automatic availability notification, as described below.

The communication device 102A includes a telephone 112, a call routing device 114 and a computer 116. The telephone 112 and the computer 116 are both connected to the call routing device 114. Furthermore, the computer 116 is connected to the Internet 106, and the call routing device 114 is connected to the PSTN 104. Thus, the telephone 112 is connected to the Internet 106 via the call routing device 114 and the computer 116, and is also connected to the PSTN 104 via the call routing device 114.

The telephone 112 included in the communication device can be any standard telephone for making and receiving telephone calls through the PSTN 104. As an example, the telephone 112 may be a standard cordless telephone. In other embodiments, the telephone 112 may be replaced with a microphone, a speaker and a dial pad. Furthermore, in other embodiments, the communication device may include more than one telephone connected to the call routing device 114 using, for example, one or more dual phone jack adapters. As described in detail below, using the call routing device 114 and the computer 116, any telephone connected to the call routing device 114 can be used to make either a VoIP call or a traditional PSTN call.

In the illustrated embodiment, the computer 116 of the communication device is a personal computer, such as a desktop computer or a laptop computer. However, in other embodiments, the computer 116 may be any computing device that can be connected to the Internet 106, such as a Personal Digital Assistant (PDA). The computer 116 may be connected to the Internet 106 through any suitable modem, such as a cable modem, Digital Subscriber Line (DSL) modem or a dial-up modem. If a dial-up modem is utilized, two phone lines to the PSTN 104 are preferred so that one of the two phone lines can be used for establishing a standard PSTN call and the other phone line can be used for establishing an Internet connection for a VoIP call. However, the communication device can be operated using a single connection to the Internet 106 via, for example, a cable modem, a DSL modem or a dial-up modem, although such configuration will limit some of the features of the communication device, in particular, features that require separate connections to both the PSTN 104 and the Internet 106.

The call routing device 114 is an intelligent interface device that can selectively provide a communications link between the telephone and the PSTN 104 and/or a communications link between the telephone 112 and the Internet 106 via the computer 116 for a VoIP call. In addition, the call routing device 114 can connect a PSTN call and a VoIP call. Thus, the call routing device 114 can be used to conference a PSTN call and a VoIP call using the telephone 112. Furthermore, the call routing device 114 can automatically initiate either a PSTN call through the PSTN 104 or a VoIP call through the Internet 106 and then connect that call to an existing call, which may either be a PSTN call or a VoIP call. As an example, the call routing device 114 can receive a PSTN call from the PSTN 104, and in response, automatically initiate a VoIP call through the Internet 106 and then connect the VoIP call with the received PSTN call for call routing.

The call routing device 114 operates in conjunction with an accompanying program, including the automatic notification module 110, running on the computer 116. The accompanying program performs functions to execute various operations of the communication device. The accompanying program and its functions are described in more detail below. In the illustrated embodiment, the call routing device 114 is a separate device from the telephone 112 and the computer 116. In other embodiments, the call routing device 114 may be integrated into the telephone 112 or the computer 116.

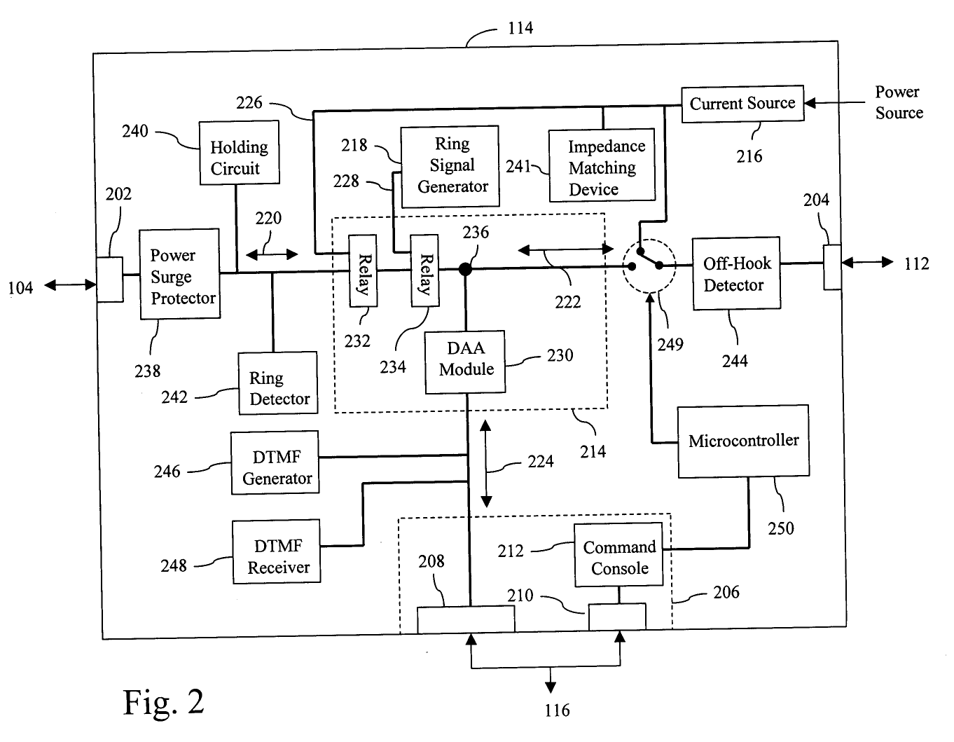

Turning now to FIG. 2, a block diagram of the components of the call routing device 114 in accordance with an embodiment of the invention is shown. The call routing device 114 includes RJ11 ports 202 and 204 (“telephone jacks”) and a computer port 206, which are interfaces to the telephone 112, PSTN 104 and the computer 116. The RJ11 port 202 is used to connect the call routing device 114 to the PSTN 104, while the other RJ11 port 204 is used to connect the call routing device to the telephone 112. The computer port 206 is used to connect the call routing device 114 to the computer 116. In this embodiment, the computer port 206 includes a voice port 208, which is connected to the soundcard of the computer 116, and an RS232 port 210, which is connected to the RS232 port of the computer. The computer port 206 also includes a command console 212, which codes and decodes signals transmitted between the call routing device 114 and the computer 116 through the RS232 port. In other embodiments, the computer port 206 may be any type of computer interface port that can be used to interface with a computer for voice and data transmissions, such as a Universal Serial Bus (USB) port, or any type of terminal that can be connected to the internal bus of the computer 116. In still other embodiments, the computer port 206 may be a wireless transceiver to interface with a computer for voice and data transmissions, such as a Bluetooth transceiver (BLUETOOTH is a trademark of Bluetooth SIG, Inc.).

The call routing device 114 further includes a switching unit 214, a current source 216 and a ring signal generator 218. The RJ11 and computer ports 202, 204 and 206 are interconnected at the switching unit 214. The RJ11 ports 202 and 204 are connected to the switching unit 214 by signal paths 220 and 222, respectively, while the computer port 206 is connected to the switching unit by a signal path 224. The signal paths 220, 222 and 224 are interconnected at an interconnecting node 236. Although not illustrated in FIG. 2, each of the signal paths 220 and 222 connected to the RJ11 ports 202 and 204 and a part of the signal path 224 directly connected to the interconnecting node 236 includes two electrical lines that correspond to “tip” and “ring” lines. The switching unit 214 operates to selectively connect the signals paths 220, 222 and 224 so that voice communication signals can be transmitted between the telephone 112, the PSTN 104 and/or the computer 116. The current source 216 and the ring signal generator 218 are connected to the switching unit 214 via electrical lines 226 and 228, respectively. Although not shown, the current source 216 is electrically connected to other components of the call routing device 114 to provide electrical power in the form of current.

The switching unit 214 of the call routing device 114 includes a data access arrangement (DAA) module 230 and relays 232 and 234. The DAA module 230 is positioned along the signal path 224, while the relays 232 and 234 are serially positioned along the signal path 220. The DAA module 230 can be any commercially available DAA module. As an example, the DAA module 230 may be a DAA module, model XE0092, supplied by Xecom, Inc. Since a DAA module is a common component found in modems, the DAA module 230 is not described in detail herein.

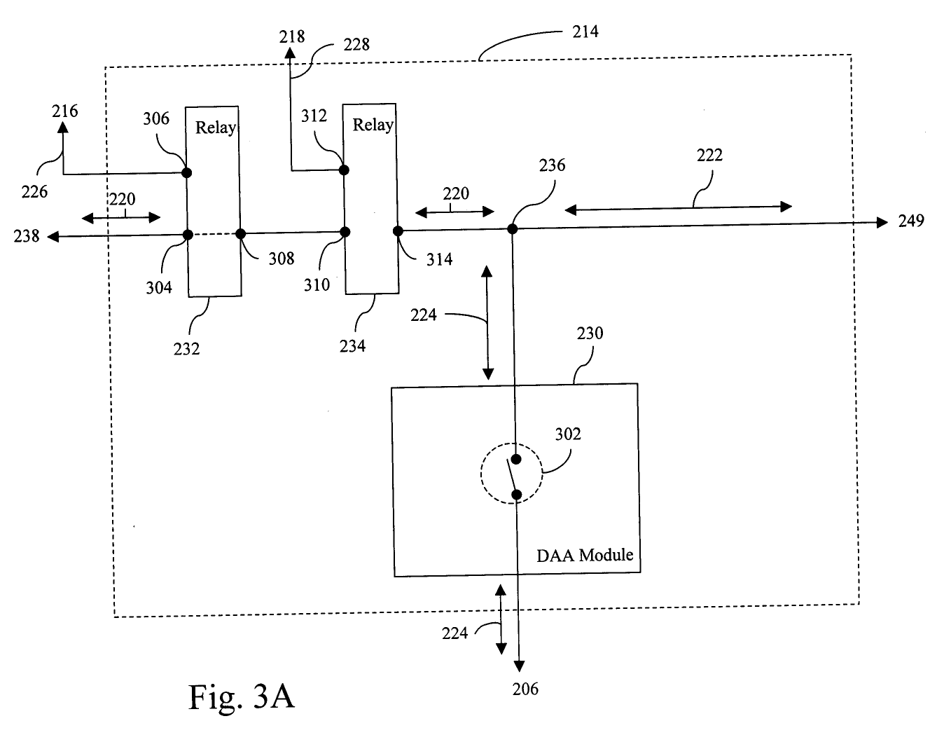

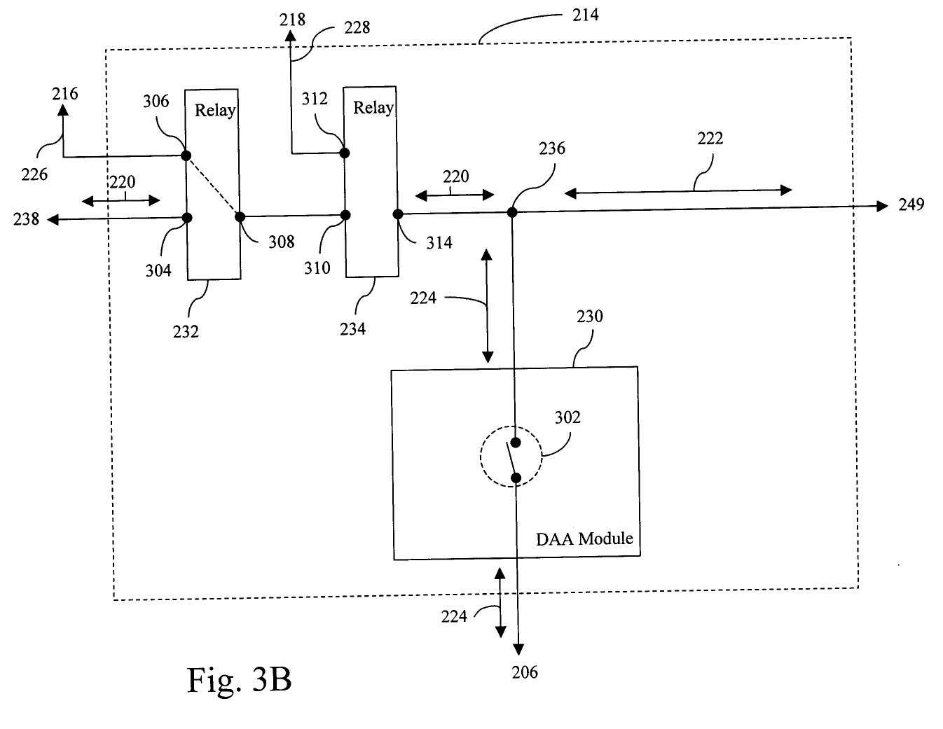

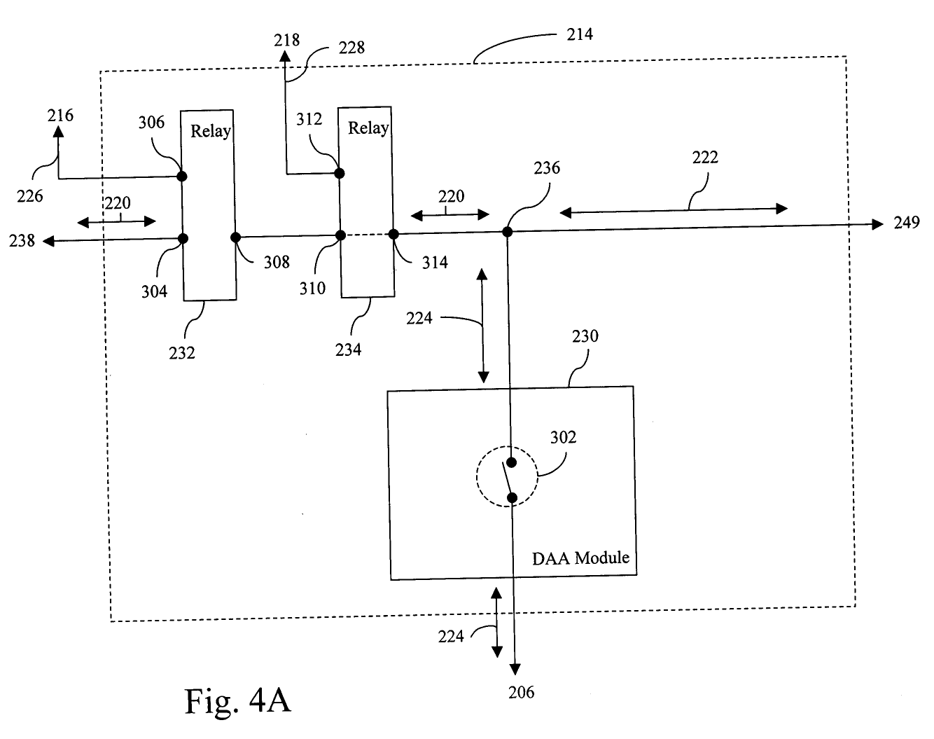

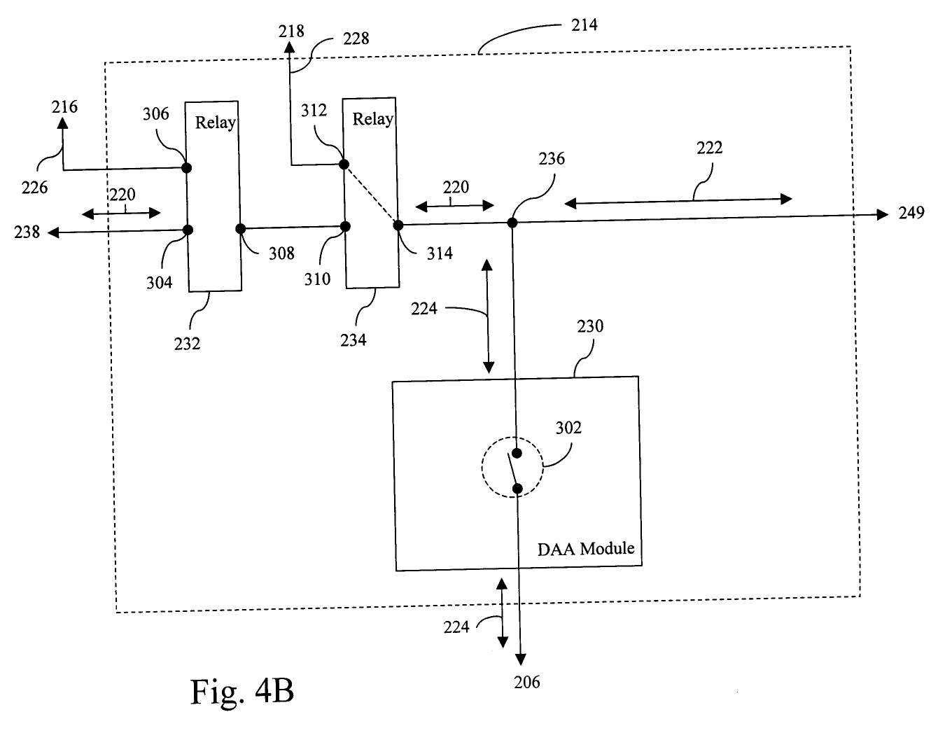

In this embodiment, the DAA module 230 includes an internal switching mechanism, shown as a switch 302 in FIGS. 3A, 3B, 4A and 4B, to selectively disconnect the signal path 224 from the signal paths 220 and 222. Thus, the DAA module 230 can provide voice signal isolation of the Internet-connected computer 116 from the telephone 112 and the PSTN 104. When the call routing device 114 is used exclusively for a standard PSTN call, the internal switch 302 of the DAA module 230 is opened to disconnect the signal path 224 from the telephone 112 and the PSTN 104 since a voice communications link to the Internet 106 via the computer 116 is not needed. The internal switch 302 can also be selectively opened during a conference session between a PSTN call and a VoIP call to isolate the VoIP call from the standard phone call for privacy and during the initiation of a PSTN call for a conference session when a VoIP call has already been established. Initially, the internal switch 302 of the DAA module 230 is opened until instructed to close, as described below. The DAA module 230 also includes various electronic components (not shown) to provide: isolation of sensitive electronic components of the call routing device 114 from the higher voltage on the telephone line which is present on the signal path 220 within the call routing device; two-to-four wire conversion; ring detection; caller identification (ID) detection; and remote disconnect (hang-up) detection.

The relays 232 and 234 operate as switching mechanisms to selectively connect/disconnect the signal path 220 and to selectively connect/disconnect the current source 216 and the ring signal generator 218, respectively, to the common node 236. The relay 232 is used to disconnect the signal path 220 to isolate the PSTN 104 from the telephone 112 and the Internet-connected computer 116. In addition, the relay 232 is used to connect the current source 216, which is connected to an external power supply, to the common node 236 via the electrical line 226 to provide power in the form of current to the telephone 112 and the front-end of the DAA module 230 when the PSTN 104 is disconnected from the telephone and the DAA module. Thus, the power from the current source 216 replaces the power supplied from the PSTN 104. Similarly, the relay 234 is used to disconnect the signal path 220 and to connect the ring signal generator 218 to the common node 236 via the electrical line 228 to transmit ring signals to the telephone 112.

As shown in FIGS. 3A, 3B, 4A and 4B, the relay 232 includes two terminals 304 and 306 on one side (“left terminals”) and a single terminal 308 on the other side (“right terminal”). The left terminal 304 of the relay 232 is connected to the signal path 220, while the other left terminal 306 is connected to the current source 216 via the electrical line 226. In this embodiment, the current source 216 is an AC-to-DC converter that receives alternating current from an external power supply and provides a stable direct current. In other embodiments, the current source 216 may provide direct current using one or more batteries. The right terminal 308 of the relay 232 can be connected to the common node 236 via the second relay 232, and thus, can be connected to the telephone 112 via the signal path 222.

In one state, e.g., when the relay 232 is not activated, as illustrated in FIG. 3A, the left terminal 304 is connected to the right terminal 308, and thus, the PSTN 104 can be connected to the telephone 112 via the second relay 234. Thus, the current source 216 is not connected to the signal path 220. In another state, e.g., when the relay 232 is activated, as illustrated in FIG. 3B, the left terminal 304 is disconnected from the right terminal 308 and the other left terminal 306 is connected to the right terminal 308. Thus, in this state of the relay 232, the current source 216 can be connected to the signal path 220 and to the common node 236 via the signal path 220 through the second relay 234. Since the telephone 112 and the DAA module 302 are connected to the common node 236, this power from the current source 216 is supplied to the front-end of the DAA module 230 and to the telephone 112.

Similar to the first relay 232, the second relay 234 includes left terminals 310 and 312 and a right terminal 314. The left terminal 310 of the relay 234 is connected to the right terminal 308 of the relay 232, while the other left terminal 312 is connected to the ring signal generator 218 via the electrical line 228. The right terminal 314 of the relay 234 is connected to the common node 236, and thus, can be connected to the telephone 112 via the signal path 222. The ring signal generator 218 provides electrical signals (“ring signals”) to ring the telephone 112 in response to an incoming VoIP call. For a standard PSTN call, the ring signals are provided by the nearest central office (not illustrated) of the PSTN 104. However, for a VoIP call, the ring signals must be generated locally. The ring signal generator 218 serves this purpose. The signals provided by the ring signal generator 218 can differ from the signals provided by the central office so that a different ring pattern will be produced by the telephone 112 for a VoIP call, allowing a listener to readily distinguish between an incoming VoIP call and an incoming standard PSTN call.

In one state, e.g., when the relay 234 is not activated, as illustrated in FIG. 4A, the left terminal 310 is connected to the right terminal 314, and thus, the PSTN 104 or the current source 216 can be connected to the telephone 112 through the relay 234. In another state, e.g., when the relay 234 is activated, as illustrated in FIG. 4B, the left terminal 310 is disconnected from the right terminal 314 and the other left terminal 312 is connected to the right terminal 314. In this state of the relay 234, the ring signal generator 218 is connected to the common node 236, and thus, can be connected to the telephone 112 so that ring signals from the ring signal generator are transmitted to the telephone to ring the telephone in response to an incoming VoIP call.

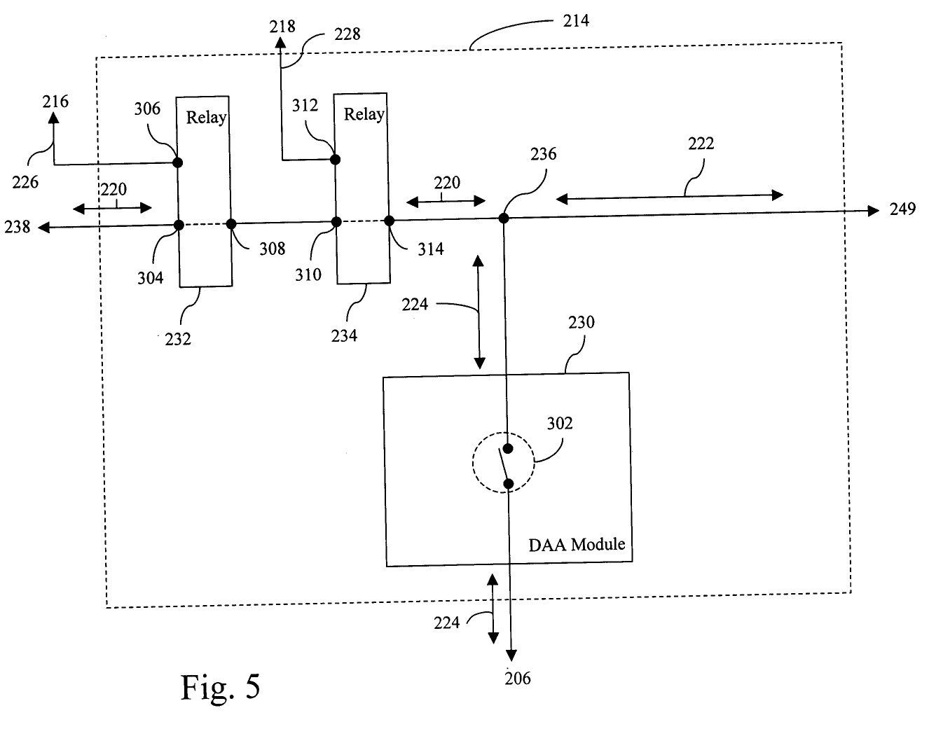

FIG. 5 illustrates the default state for the switching unit 214. In this default state, the relays 232 and 234 are both deactivated. Thus, for the relay 232, the left terminal 304 is connected to the right terminal 308. Similarly, for the relay 234, the left terminal 310 is connected to the right terminal 314. Consequently, in the default state of the switching unit 214, the PSTN 104 can be connected to the telephone 104 via the signal paths 220 and 222.

Turning back to FIG. 2, the call routing device 114 further includes a power surge protector 238, a holding circuit 240, an impedance matching device 241, a ring detector 242, an off-hook detector 244, a dual tone multi-frequency (DTMF) generator 246, a DTMF receiver 248, a switching mechanism 249 and a microcontroller 250. The power surge protector 238 is coupled to the RJ11 port 202 to protect other components of the call routing device 114 against power surges from the PSTN 104. The holding circuit 240 is connected to the signal path 220 between the power surge protector 238 and the switching unit 214. The holding circuit 240 operates to maintain a closed electrical loop between the “tip” and “ring” lines of the signal path 220 to place a standard PSTN call on hold, e.g., during an initiation of a VoIP call.

The impedance matching device 241 is connected to the electrical line 226 that connects the current source 216 to the relay 232 of the switching unit 214. The impedance matching device 241 provides impedance that matches the impedance on the line to the PSTN 104 when the PSTN is disconnected by the relay 232 of the switching unit 214, which results in a more effective echo cancellation by the DAA module 230. As an example, the impedance matching device provides a 600 Ohm resistance.

The ring detector 242 is also connected to the signal path 220 between the power surge protector 238 and the switching unit 214. The ring detector 242 operates to detect ring signals from the PSTN 104, indicating an incoming PSTN call. The ring detector 242 is used when the signal path 220 is disconnected by the relay 232 of the switching unit 214 since the DAA module 230 cannot then be used to detect ring signals from the PSTN 104. The off-hook detector 244 is located on the signal path 222 between the switching unit 214 and the RJ11 port 204. The off-hook detector 244 operates to detect whether the telephone 112 is on-hook or off-hook.

The DTMF generator 246 is connected to the signal path 224 between the DAA module 230 and the computer port 206. The DTMF generator 246 is used to generate DTMF tones to initiate a PSTN call from the call routing device 114. The DTMF receiver 248 is also connected to the signal path 224 between the DAA module 230 and the computer port 206. The DTMF receiver 248 is used to decode DTMF tones received from the PSTN 104 or the telephone 112 so that commands in the form of DTMF tones can be used to operate the call routing device 114 and/or the accompanying program running on the computer.

The switching mechanism 249 is located on the signal path 222 between the switching unit 214 and the off-hook detector 244. The switching mechanism 249 operates to selectively connect the off-hook detector 244 to either the switching unit 214 or the current source 216. Thus, the telephone 112 can be disconnected from the PSTN 104 and the Internet-connected computer 116, and be connected to the current source 216 by the switching mechanism 249. The default state of the switching mechanism 249 is to connect the off-hook detector 244 to the current source 216 so that the off-hook detector can receive power and remain in operation. This default state is changed when the switching mechanism 249 is instructed by the microcontroller 250 to connect the off-hook detector 244 to the switching unit 214. Consequently, the telephone 112 can then be connected to the PSTN 104 through the switching unit 214. The switching mechanism 249 is designed such that when there is a loss of power to the call routing device 114, the switching mechanism 249 is set to connect the off-hook detector 244 to the switching unit 214 so that the telephone 112 can be used. As described further below, the switching mechanism 249 can be used to prevent someone from listening to a telephone call established through the Internet-connected computer 116 and the PSTN 104 using the telephone 112. Furthermore, the switching mechanism 249 can be used to prevent the telephone 112 from receiving ring signals of an incoming telephone call from the PSTN 104 until a caller ID information of the call has been received and approved. In this embodiment, when the telephone 112 is connected to the current source 216 by the switching mechanism 249, a signal indicating that the telephone is disconnected from the Internet-connected computer 116 and the PSTN 104 is provided by the microcontroller 250. In other embodiments, this signal may be provided by another device, which may provide the signal in the form of a recorded audio message.

The microcontroller 250 is connected to all the active components of the call routing device 114. The microcontroller 250 controls or receives information from these active components so that the call routing device 114 can perform various operations, as described in detail below. The microcontroller 250 can also modulate the ring signals generated by the ring signal generator 218 by repeatedly and selectively activating and deactivating the relay 234 of the switching unit 214 so the ring pattern produced by the telephone 112 in response to the modulated ring signals can be controlled.

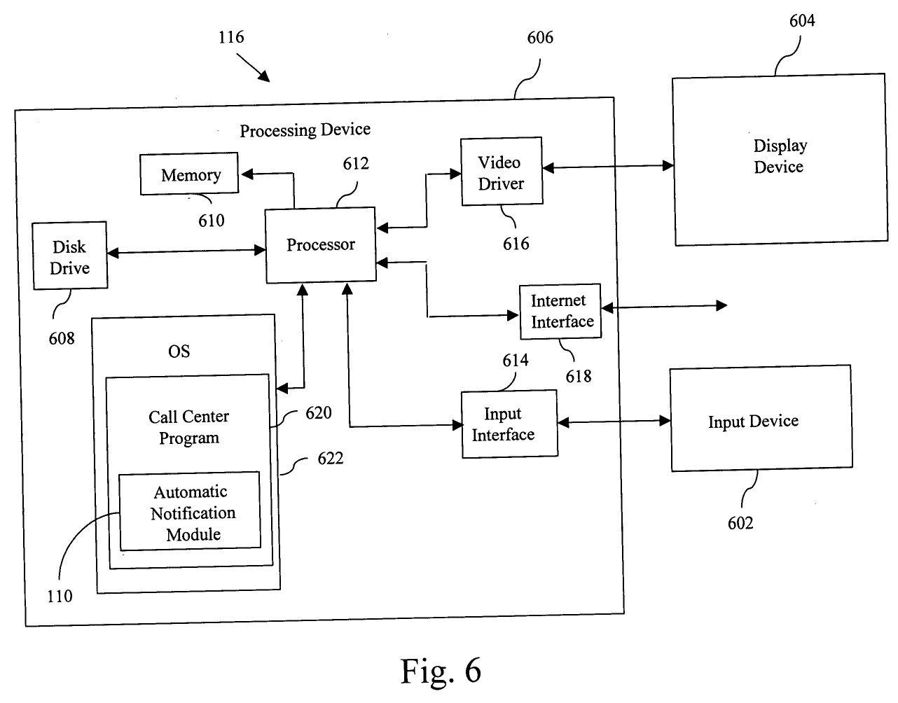

Turning now to FIG. 6, a block diagram of the components of the computer 116 in accordance with an embodiment of the invention is shown. The computer 116 includes an input device 602, a display device 604 and a processing device 606. Although these devices are shown as separate devices, two or more of these devices may be integrated together. The input device 602 allows a user to input commands into the computer 116. The input device 602 may include a computer keyboard and a mouse. The input device 602 may also include a microphone for entering voice commands into the computer 116. However, the input device 602 may be any type of electronic input device, such as buttons, dials, levers and/or switches on the processing device 606. Alternatively, the input device 602 may be part a touch-sensitive display that allows a user to input commands using a stylus. The display device 604 may be any type of a display device, such as those commonly found in personal computer systems, e.g., CRT monitors or LCD monitors.

The processing device 606 of the computer 116 includes a disk drive 608, memory 610, a processor 612, an input interface 614, a video driver 616 and an Internet interface 618. The processing device 606 further includes a call center program 620 running on an operating system 622. The call center program 620 is the accompanying program for the call routing device 114 that operates with the call routing device 114 to perform various call management operations. The call center program 620 includes the automatic notification module 110. In one embodiment, the call center program 620 and the automatic notification module 110 are implemented as software. In this embodiment, the call center program 620 and the automatic notification module 110 may be installed in the computer 116 from a portable computer readable storage medium, such as a compact disk (CD), having instructions that are executable by the processor 612. However, the call center program 620 and the automatic notification module 110 may be implemented in any combination of hardware, firmware and/or software.

The disk drive 608, the memory 610, the processor 612, the input interface 614, the video driver 616 and the modem 618 are components that are commonly found in personal computers. The disk drive 608 provides a means to input data into the computer 116 from a portable storage medium. As an example, the disk drive 608 may a CD drive to read data from an inserted CD. The memory 610 is a storage medium to store various data utilized by the computer 116. The memory 610 may be a hard disk drive, read-only memory (ROM) or other forms of memory. The processor 612 may be any type of digital signal processor that can run the call center program 620. The input interface 614 provides an interface between the processing device 606 and the input device 602. The video driver 616 drives the display device 604. The Internet interface 618 provides a connection to the Internet 106. The Internet interface 618 may be a broadband modem, such as a DSL or cable modem, or a dial-up modem that uses the PSTN 104 to connect to the Internet 106. Alternatively, the Internet interface 618 may be a network card, which may be wireless, to connect to a computer network that is connected to the Internet. In order to simplify the figure, additional components that are commonly found in a processing device of a personal computer system are not shown or described.

As stated above, the call routing device 114 operates in conjunction with the call center program 620 running on the computer 116 to perform various operations to enable telecommunication-related functionalities of the communication device 102A, such as making a standard PSTN call and/or a VoIP call, receiving a PSTN call and/or VoIP call, conferencing a PSTN call and a VoIP call, and routing an incoming VoIP call to a remote telephone using a PSTN call and vice versa.

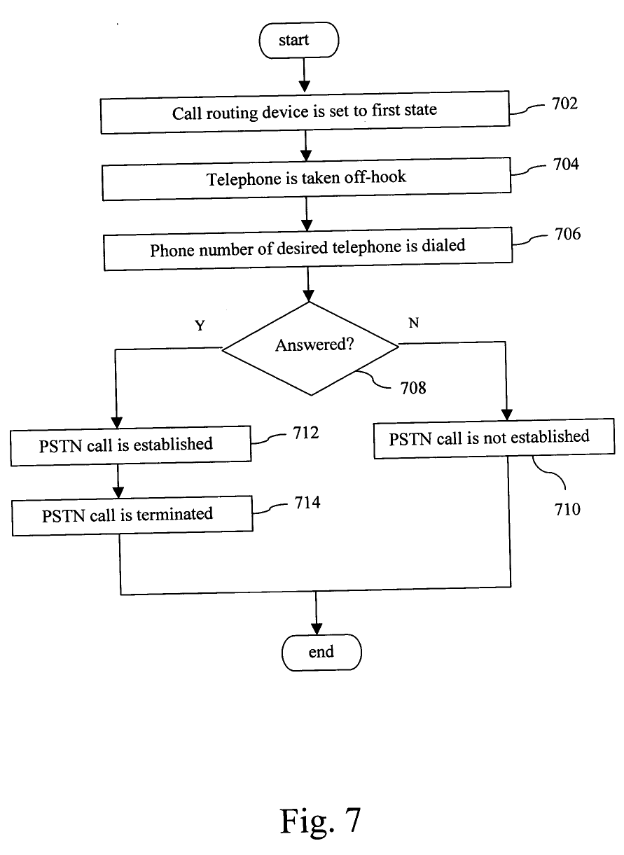

The processes for performing various telecommunication-related operations using the telecommunications system 100 are now described. The process for making a standard PSTN call from the communication device 102A in accordance with an embodiment is described with reference to the flow diagram of FIG. 7. At block, the call routing device 114 is set to a first state in which both of the relays 232 and 234 are deactivated, the internal switch 302 of the DAA module 230 is opened, and the switching mechanism 249 is set to connect the off-hook detector 244 to the current source 216. This first state of the call routing device 114 may be the default state for the device. Even though the telephone 112 is disconnected from the PSTN 104 in the first state of the call routing device 114, the telephone 112 can be used in a normal manner to connect to a remote telephone through the PSTN 104. At block 704, the telephone 112 is taken off-hook by the caller to initiate a PSTN call. In addition, at block 704, the internal switch 302 of the DAA module is 230 is closed in response to the telephone 112 being taken off-hook. The closing of the internal switch 302 of the DAA module 230 connects the computer port 206 to the RJ11 port 204, connecting the telephone 112 to the Internet-connected computer 116. Furthermore, at block 704, the switching mechanism 249 is switched to connect the off-hook detector 244 to the switching unit 214 in response to the telephone 112 being taken off-hook, connecting the telephone to the PSTN 104. The off-hook status is detected by the microcontroller 250 via the off-hook detector 244, and then the states of the internal switch 302 and the switching mechanism 249 are changed by the microcontroller in response to the detected off-hook status.

Next, at block 706, the phone number of the desired remote telephone is dialed to send a request in the form of ring signals to establish the PSTN call. Next, at block 708, the ringing remote telephone is either answered or not answered. If the remote telephone is not answered, then the PSTN call is not established, at block 710, and the process comes to an end. If the remote telephone is answered, then the PSTN call is established, at block 712. Next, at block 714, the PSTN call is terminated when one of the two parties of the phone call hangs up the respective telephone.

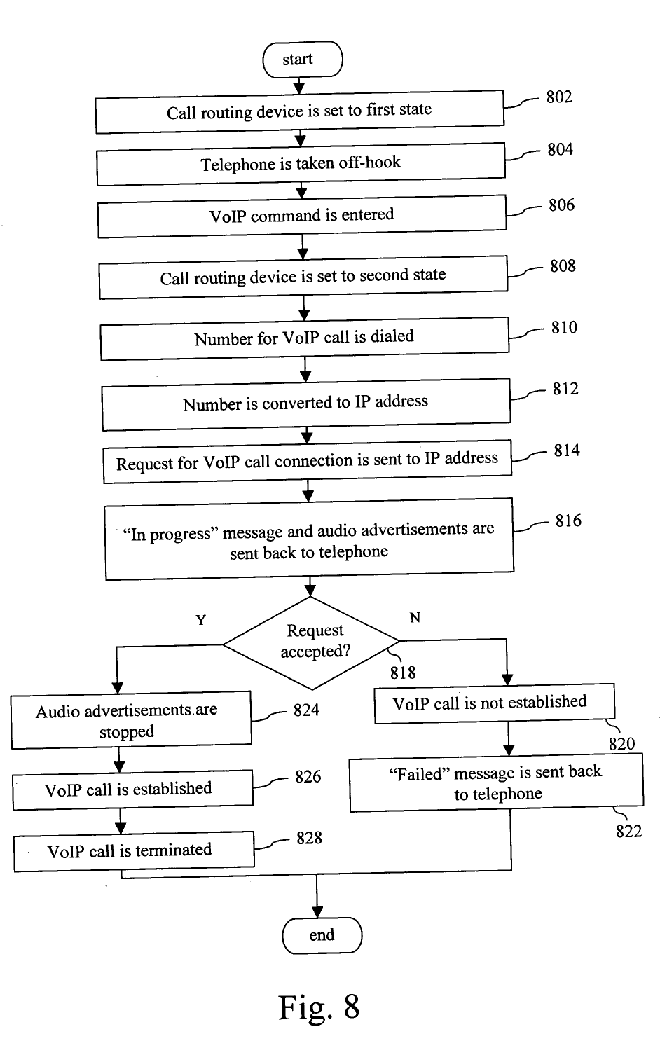

The process for making a VoIP call from the communication device 102A in accordance with an embodiment is described with reference to the flow diagram of FIG. 8. Initially, at block 802, the call routing device 114 is set to the first state. Next, at block 804, the telephone 112 is taken off-hook by a caller to initiate a VoIP call. In addition, at block 804, the internal switch 302 of the DAA module is 230 is closed and the switching mechanism 249 is switched to connect the off-hook detector 244 to the switching unit 214 in response to the telephone 112 being taken off-hook. Next, at block 806, the caller enters a VoIP command using the telephone dial pad to change the state of the call routing device 114 from the first state to a new second state for making a VoIP call. As an example, the command may be the “#” button on the telephone dial pad. This command in the form of a DTMF tone is received by the DTMF receiver 248 of the call routing device 114 and a signal is then transmitted to the microcontroller 250 of the device. In response, at block 808, the call routing device 114 is set to the second state by the microcontroller 250 in which the relay 232 is activated. The activation of the relay 232 disconnects the signal path 220 and connects the power supply 216 to the telephone 112 and the DAA module 230, as described above.

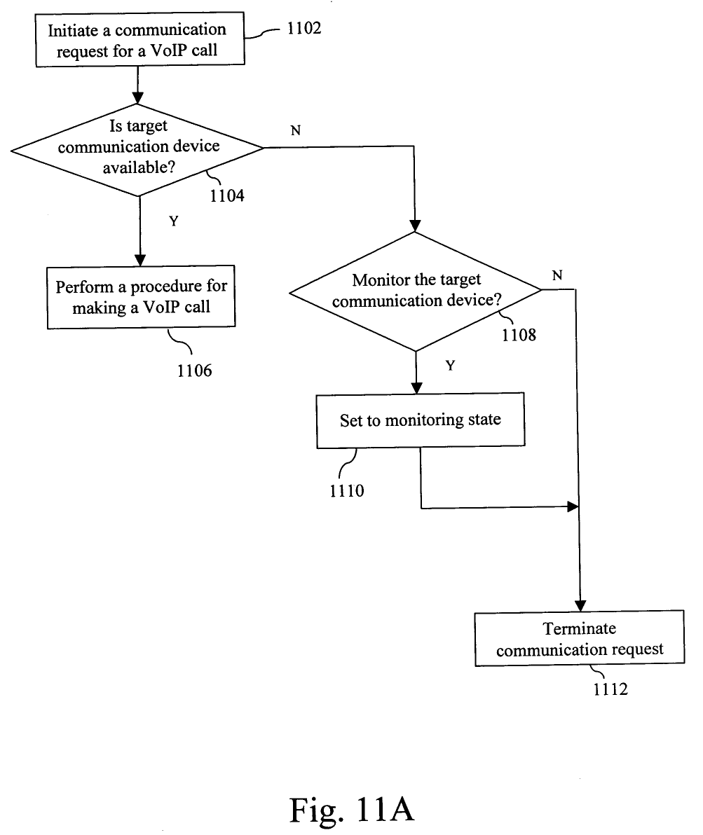

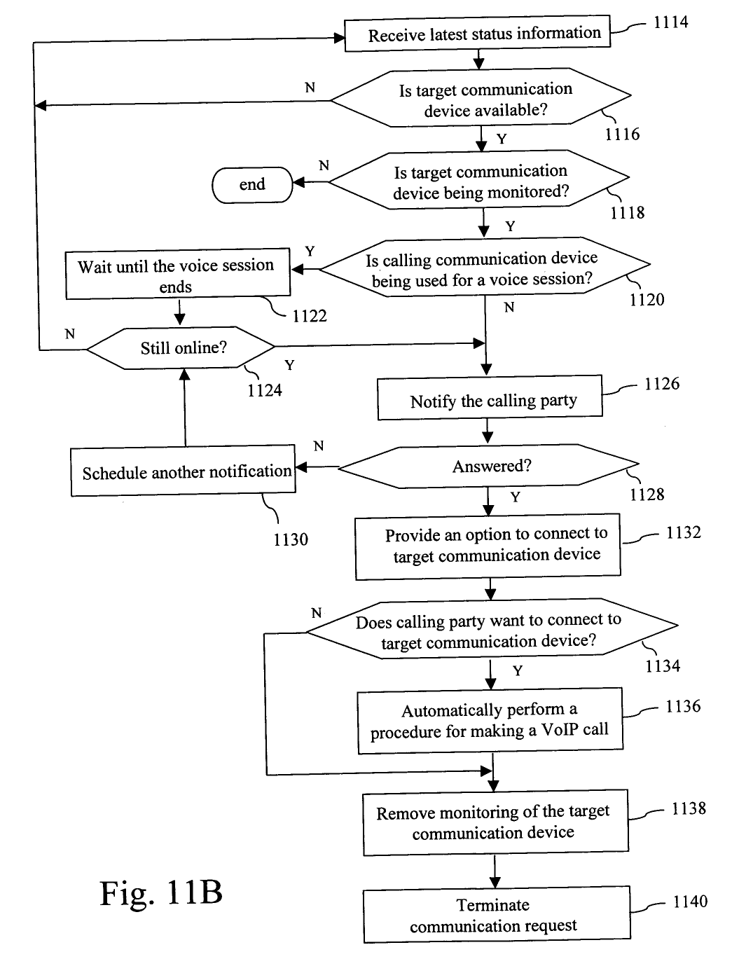

Next, at block 810, the number associated with the remote Internet-connected computer for the VoIP call is dialed by the caller using the dial pad of the telephone 112. The dialed number can be a single digit number or a multi-digit number, which corresponds to an IP address of the remote computer. The dialed number in the form of DTMF tones is received by the DTMF receiver 248 of the call routing device 114, where each of the received DTMF tones is converted to a corresponding signal and transmitted to the computer 116 via the microcontroller 250 and the computer port 206 of the device. Next, at block 812, the dialed number is converted to the corresponding IP address of the remote Internet-connected computer by the call center program 620 running in the computer 116. Next, at block 814, a request to establish a VoIP call connection is sent by the call center program 620 to the IP address of the remote Internet-connected computer via the VoIP network 108. It is assumed here that the automatic availability notification feature of the communication device 102A is disabled and that the remote Internet-connected computer is available to receive a VoIP call from the communication device 102A. The automatic availability notification feature of the communication device 102A is described below with reference to a flow diagram of FIG. 11A and 11B. Next, at block 816, an informational voice message is sent back to the telephone 112 by the call center program 620, informing the caller that the VoIP call connection is in progress. Furthermore, one or more audio advertisements may also be sent back to the telephone 112 during the connecting period. These advertisement slots may be a basis for a method for commercializing on the use of the communication device 102A for VoIP calls. New advertisements may be periodically downloaded to the computer 116 of the communication device 102A through the Internet 106. Depending on the number of the communication devices, such as the communication device 102A, being used for VoIP calls, such advertisements can reach a large number of audiences, which allows for generation of revenue from the sales of the advertisement slots.

Next, at block 818, the request is accepted or not accepted (timed out) at the remote Internet-connected computer. If the request is not accepted, a VoIP call is not established, at block 820, and another informational voice message may be sent to the telephone 112 by the call center program 620, informing the caller that the VoIP call connection has failed, at block 822. The process then comes to an end. However, if the request is accepted at the remote Internet-connected computer, the audio advertisements are stopped by the call center program 620, at block 824, and the VoIP call is established, at block 826.

The established VoIP call is then terminated, at block 828. The VoIP call is terminated by the call center program 620 when the caller hangs up the telephone 112. The off-hook detector 244 of the call routing device 114 detects the on-hook status of the telephone 112 and sends an on-hook signal to the call center program 620 via the microcontroller 250. In response, the call center program 620 disconnects the VoIP call. The VoIP call is also terminated when the VoIP call connection is disconnected.

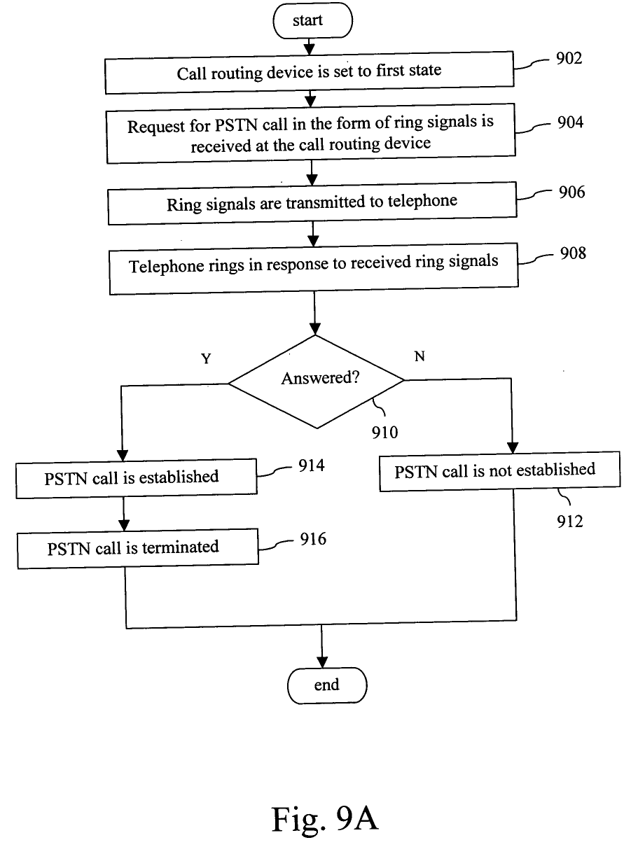

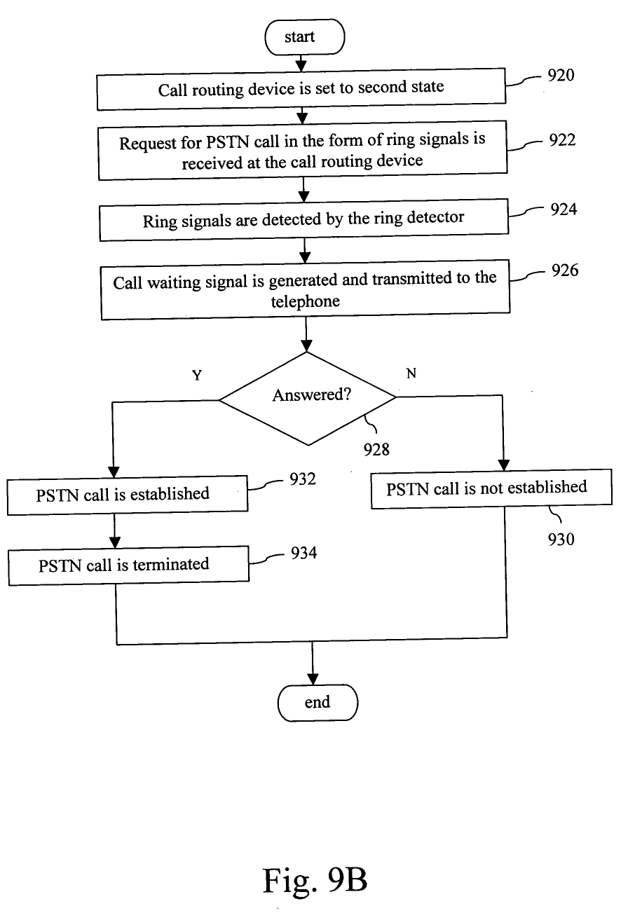

The process for receiving a PSTN call at the communication device 102A when the communication device is not currently being used for a VoIP call in accordance with an embodiment is described with reference to the flow diagram of FIG. 9A. Initially, at block 902, the call routing device 114 is set to the first state. Next, at block 904, a request from the PSTN 104 in the form of ring signals to establish a PSTN call is received at the call routing device 114 through the RJ11 port 202. In response, the switching mechanism 249 is switched to connect the switching unit 214 to the off-hook detector 244, connecting the telephone 112 to the switching unit. Since the switching mechanism 249 connects the PSTN 104 to the telephone 112, the received ring signals are transmitted to the telephone 112, at block 906. Next, at block 908, the telephone 112 rings in response the received ring signals. Next, at block 910, the ringing telephone 112 is either answered or not answered. If the telephone 112 is not answered, then the PSTN call is not established, at block 912, and the process comes to an end. If the telephone 112 is answered, then the PSTN call is established, at block 914. Next, at block 916, the PSTN call is terminated when one of the two parties of the phone call hangs up the respective telephone.

The process for receiving a PSTN at the communication device 102A when the communication device is currently being used for a VoIP call in accordance with an embodiment is described with reference to the flow diagram of FIG. 9B. Since the communication device 102A is being used for a VoIP call, the call routing device 114 is initially set to the second state in which the relay 232 is activated, disconnecting the signal path 220 to the PSTN 104. In addition, the switching mechanism 249 is set to connect the telephone 112 to the switching unit 214 and the internal switch 302 of the DAA module 230 is closed, connecting the telephone 112 to the computer 116, at block 920. Next, at block 922, a request from the PSTN 104 in the form of ring signals to establish a PSTN call are received at the call routing device 114 through the RJ11 port 202. Next, at block 924, the received ring signals are detected by the microcontroller 250 of the call routing device 114 via the ring detector 242. Next, at block 926, a call waiting signal is generated and transmitted to the telephone 112 by the microcontroller 250, indicating an incoming PSTN call. As an example, the call waiting signal may be generated by the DTMF generator 246 or the microcontroller 250. Next, at block 928, the incoming PSTN call is either answered or not answered. As an example, the incoming PSTN call can be answered by taking the telephone 112 on-hook and then off-hook in a short period of time, which puts the VoIP call on hold and connects the telephone 112 to the PSTN 104 (i.e., the relay 232 of the call routing device 114 is deactivated). The VoIP call can be placed on hold by opening the internal switch 302 of the DAA module 230 or by muting the VoIP call at the computer 116 by the call center program 620.

If the incoming call is not answered, then the PSTN call is not established, at block 930, and the process comes to an end. If the incoming call is answered, then the PSTN call is established, at block 932. Next, at block 932, the PSTN call is terminated when one of the two parties of the PSTN call hangs up the respective telephone.

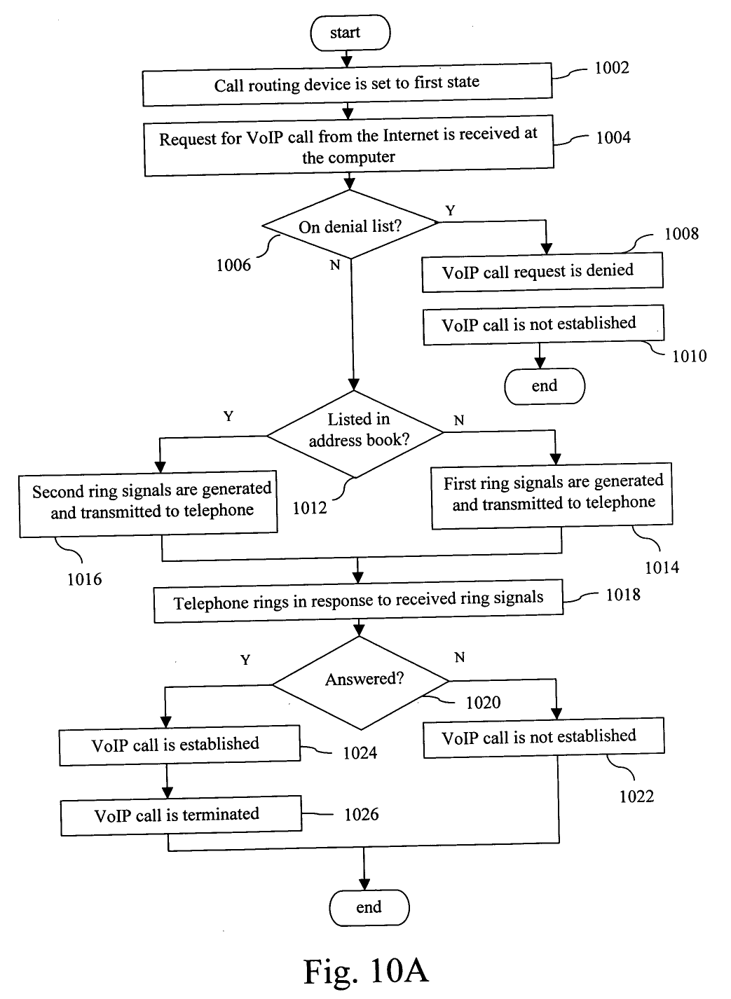

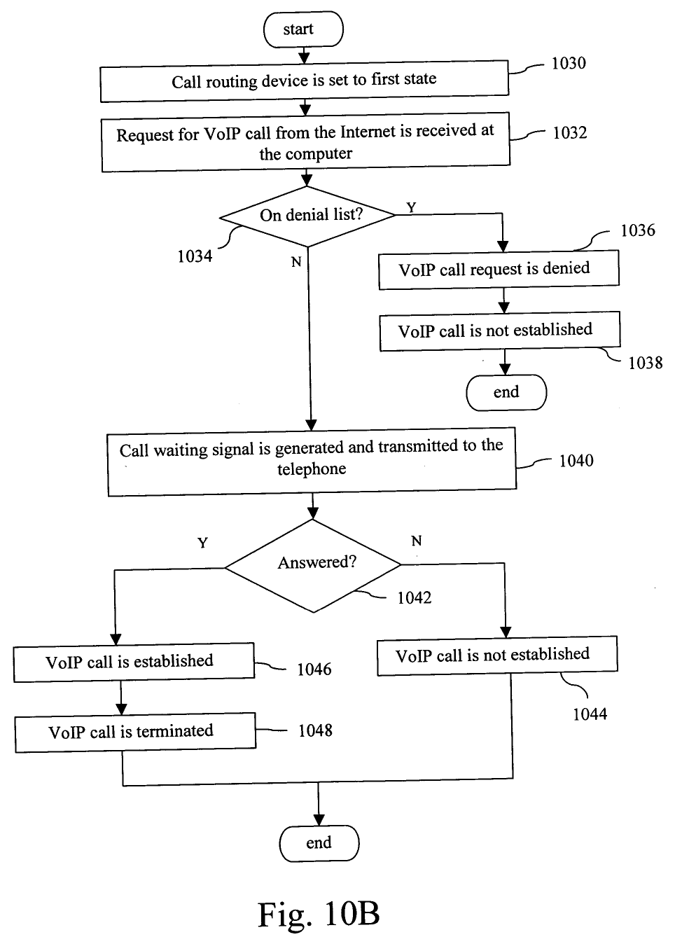

The process for receiving a VoIP call at the communication device 102A when the communication device is not currently being used for a PSTN call in accordance with an embodiment is described with reference to the flow diagram of FIG. 10A. Initially, at block 1002, the call routing device 114 is set to the first state. Next, at block 1004, a request for VoIP call from the instant messaging network of the Internet 106 is received at the computer 116. Next, at block 1006, a determination is made by the call center program 620 whether the calling party is on a denial list. The denial list is a list of parties (e.g., IP addresses and phone numbers) from which the user of the communication device 102A does not want to receive calls. This denial list is stored in the computer 116 and used by the call center program 620. Alternatively, at block 1006, a determination is made by the call center program 620 whether the calling party is not on an address book. The address book is another list of parties from which the user of the communication device 102A does want to receive calls. Similar to the denial list, the address book is also stored in the computer 116 and used by the call center program 620. The decision to use the denial list or the address book may be set by the user using the call center program 620.

If the calling party is on the denial list, or alternatively, not on the address book, the VoIP call request is automatically denied by the call center program 620, at block 1008, and the VoIP call is not established, at block 1010. The process then comes to an end. However, if the calling party is not on the denial list, another determination is made by the call center program 620 whether the calling party is listed in the address book, at block 1012. If the address book was used to determine whether the VoIP call request should be denied, then this second determination is not needed.

If the calling party is not listed in the address book, the switching mechanism 249 is switched to connect the telephone 112 to the switching unit 214 and first ring signals are generated and transmitted to the telephone 112, at block 1014. This is achieved by sending an appropriate signal to the microcontroller 250 of the call routing device 114 by the call center program 620. In response, the microcontroller 250 controls the switching mechanism 249 to connect the telephone 112 to the switching unit 214, the ring signal generator 218 to generate the first ring signals, and the relay 234 to the activated state to transmit the ring signals to the telephone 112. If the calling party is listed in the address book, the switching mechanism 249 is switched to connect the telephone 112 to the switching unit 214 and second ring signals that differ from the first ring signals are generated and transmitted to the telephone 112, at block 1016. This is achieved in a similar manner as the generation and transmission of the first ring signals except that the ring signal generator 218 is controlled to generate different ring signals. The ringing pattern of the telephone 112 depends on the ring signals applied to the telephone. Thus, different ring signals will produce different ringing patterns, which allow a listener to distinguish between calling parties. The ring signals for any calling party listed in the address book may be identical so that the telephone 112 rings with the same ringing pattern when a VoIP call is from any party listed in the address book. Alternatively, the ring signals can vary for each calling party in the address book or for different categories of parties in the address book to distinguish between different calling parties that are listed in the address book. As an example, the ring signals for a calling party in a “business” category of the address book may be different from the ring signals for a calling party in a “friends” category of the address book.

Next, at block 1018, the telephone 112 rings in response the received ring signals. Next, at block 1020, the ringing telephone 112 is either answered or not answered. If the telephone 112 is not answered, then the VoIP call is not established, at block 1022, and the process comes to an end. If the telephone is answered, then the VoIP call is established, at block 1024. Next, at block 1026, the VoIP call is terminated when the called party hangs up the telephone 112 or when the VoIP call connection is disconnected.

The process for receiving a VoIP call at the communication device 102A when the communication device is currently being used for a PSTN call in accordance with an embodiment is described with reference to the flow diagram of FIG. 10B. Initially, at block 1030, the call routing device 114 is set to the first state, which allows the PSTN call between the telephone 112 and the PSTN 104. Next, at block 1032, a request for VoIP call from the instant messaging network of the Internet 106 is received at the computer 116. Next, at block 1034, a determination is made by the call center program 620 whether the calling party is on the denial list, or alternatively, not on the address book. If so, the VoIP call request is automatically denied by the call center program 620, at block 1036, and the VoIP call is not established, at block 1038. The process then comes to an end. However, if the calling party is not on the denial list, or alternatively, on the address book, a call waiting signal is generated and transmitted to the telephone 112, at block 1040. This is achieved by sending a signal to the microcontroller 250 of the call routing device 114 by the call center program 620 to generate a call waiting signal, which may be generated by the DTMF generator 246 or the microcontroller 250.

Next, at block 1042, the incoming VoIP call is either answered or not answered. If the incoming VoIP call is not answered, then the VoIP call is not established, at block 1044, and the process comes to an end. If the incoming call is answered, then the VoIP call is established, at block 1046. As an example, the incoming VoIP call can be answered by taking the telephone 112 on-hook and then off-hook in a short period of time, which puts the PSTN call on hold and connects the telephone to the computer 116. The PSTN call is placed on hold by activating the holding circuit 240 and the relay 232 of the call routing device 114 by the microcontroller 250. Thus, the telephone 112 is disconnected from the PSTN 104, but the telephone line to the PSTN is held active by the holding circuit 240.

Since the VoIP call can also be placed on hold, the telephone 112 can be selectively switched between the PSTN call and the VoIP call using the relay 232 and the internal switch 302 of the DAA module 230 (or by muting the VoIP call by the call center program 620). Next, at block 1048, the VoIP call is terminated when the called party hangs up the telephone or when the VoIP call connection is disconnected.

In addition the above-described processes, the communication device 102A can also be configured to perform other telecommunication-related features, such as automatic call denial and voicemail for both VoIP and PSTN calls. The automatic call denial feature for VoIP calls has been described above with reference to FIGS. 10A and 10B. The voicemail feature for VoIP calls involves automatically answering an incoming VoIP call by the call center program 620, if the calling party is not on the denial list, and then allowing the caller to leave a digitally recorded message on the computer 116 after a greeting has been played to the caller. In one setting of the call center program 620, an incoming VoIP call may be automatically answered by the call center program as soon as a determination is made that the calling party is not on the denial list. In another setting of the call center program 620, an incoming call may be automatically answered by the call center program after ring signals has been generated and transmitted to the telephone 112 for a predefined period, allowing a user to answer the incoming call.

The automatic call denial feature for PSTN calls involves comparing the caller ID information, which is transmitted between the first and second ring signals from the PSTN 104, with the denial list by the call center program 620 and then allowing the subsequent ring signals to be transmitted to the telephone 112, only if the calling telephone is not on the denial list. Thus, the telephone 112 needs to be initially disconnected from the PSTN 104 by the switching mechanism 249 of the call routing device 114 so that the first ring signal is not transmitted to the telephone. The telephone 112 is connected to the PSTN 104 by the switching mechanism 249 only after the call center program 620 has determined that the calling telephone of an incoming PSTN call is not on the denial list. Furthermore, the internal switch 302 of the DAA module 230 is closed to transmit the caller ID information from the PSTN 104 to the call center program 620 in the computer 116.

The voicemail feature for PSTN calls involves automatically answering an incoming PSTN call after a predefined period, e.g., after receiving four ring signals from the PSTN 104, and then allowing the caller to leave a digital recording after a greeting has been played to the caller. When ring signals are received at the call routing device 114, the received ring signals are detected by the microcontroller 250 via the ring detector 242 or the DAA module 230 (assuming the relay 232 is not activated). After the predefined period, the incoming PSTN call is automatically answered by the microcontroller 250 by closing the internal switch 302 of the DAA module 230. The call center program 620 then plays a greeting to the caller and digitally records a voice message of the caller, if any.

In addition to the above-described telecommunication-related features, the communication device 102A further provides an automatic availability notification feature, i.e., automatically providing notifications of availability of one or more communication devices of the telecommunications system 100 to receive a VoIP call from the communication device 102A. The process for providing automatic notifications in accordance with an embodiment of the invention involves the process for making a VoIP call from the communication device 102A. Thus, the automatic notification process is described with reference to the flow diagram of FIG. 8, which illustrates the process for making a VoIP call from the communication device 102A, as well as the flow diagrams of FIGS. 11A and 11B, which illustrate the automatic notification process. At block 1102 in the flow diagram of FIG. 11A, a communication request for a VoIP call to a target communication device is initiated by a calling party at the communication device 102A. The initiation of the communication request involves steps corresponding to blocks 802-812 in the flow diagram of FIG. 8.

Next, at block 1104, a determination is made whether the target communication device is available to receive a VoIP call from the calling communication device 102A. This availability determination is made by the automatic notification module 110 in the call center program 620 using application program interface (API) provided by the VoIP network 108. The status of all communication devices that are logged on to the VoIP network 108 is maintained at the VoIP network. Thus, the automatic notification module 110 needs only to request and receive the status information of the target communication device to determine the availability of the target communication device. If the target communication device is available, then the process proceeds to block 1106, where a procedure for making a VoIP call is performed. This procedure corresponds to a portion of the process for making a VoIP call, as described above with reference to the flow diagram of FIG. 8. Specifically, the procedure corresponds the flow diagram of FIG. 8 from block 814 to the end.

However, if the target communication device is not available, the process proceeds to block 1108, where a determination is made whether the calling party at the calling communication device 102A wants to monitor the target communication device. This determination can be made by providing an audio message asking the calling party at the communication device 102A to press one or more predefined keys on the dialpad of the telephone 112 if the calling party wants to monitor the target communication device. When the predefined keys are pressed by the calling party, the DTMF receiver 248 of the call routing device 114 decodes the DTMF signals generated by the telephone 112 in response to the pressing of the dialpad keys and the decoded signals are transmitted to the microcontroller 250. The microcontroller 250 then transmits an appropriate signal to the automatic notification module 110 so that the automatic notification module can begin monitoring the availability status of the target communication device.

If the calling party at the communication device 102A indicates that the calling party does not want to monitor the availability status of the target communication device by, for example, hanging up the telephone 112, then the communication request is terminated, at block 1112. If the calling party does indicate that the calling party does want to monitor the availability status of the target communication device, then the automatic notification module 110 is set to a monitoring state to continuously monitor the availability status of the target communication device, at block 1110. In the monitoring state, the automatic notification module 110 automatically receives a change in the status information of the target communication device. The process then proceeds to block 1112, where the communication request is terminated. This process can be repeated to either establish a VoIP call to another communication device or monitor that communication device.

The automatic notification process continues at block 1114 in FIG. 11B, where the latest status information of the target communication device from the VoIP network 108 is received at the automatic notification module 110. Next, at block 1116, a determination is made by the automatic notification module 110 whether the target communication device is available to receive a VoIP call, e.g., the target communication device has logged on to the VoIP network 108. If the receiving communication device is not available, then the process proceeds back to block 1114 to receive the next latest status information of the target communication device. If the target communication device is determined to be available, then the process proceeds to block 1118, where a determination is made by the automatic notification module 110 whether the target communication device is currently being monitored by the calling communication device 102A.

If the target communication device is currently not being monitored, the process comes to an end. If the target communication device is currently being monitored, the process proceeds to block 1120, where a determination is made by the automatic notification module 110 whether the calling communication device 102A is being used for a voice session, either a PSTN call and/or a VoIP call. If the calling communication device 102A is not being used for a voice session, then the process proceeds to block 1126. However, if the calling communication device 102A is being used for a voice session, then the process proceeds to block 1122, where the automatic notification module 110 waits until the voice session ends. Next, at block 1124, a determination is made whether the target communication device is still online. If not, then the process proceeds back to block 1114, repeating at least blocks 1114-1120. However, if the target communication device is still online, then the process proceeds to block 1126.

Next, at block 1126, the calling party at the communication device 102A is notified of the availability of the target communication device by the automatic notification module 110. In an embodiment, a signal is transmitted from the automatic notification module 110 to the microcontroller 250 of the call routing device 114, which in turn instructs the ring signal generator 218 to transmit a special ring signal to the telephone 112. In response to the special ring signal, the telephone 112 rings to notify the calling party at the communication device 102A of the availability status of the target communication device.

Next, at block 1128, a determination is made whether the telephone 112 has been answered, i.e., whether the telephone has been taken off hook. If the elephone is not answered, the process proceeds to block 1130, where another notification is scheduled at some later time, e.g., five (5) minutes later. The process then proceeds back to block 1124. In order to prevent continuous repeated scheduling, the scheduling of notification may be limited to, for example, two (2) times. After this limitation has been reached, the process may simply come to an end.

If the telephone is answered, then the process proceeds to block 1132, where an option to connect to the target communication device is provided to the calling party at the communication device 102A by the automatic notification device 110. The option may be provided in the form of an audio message, instructing the calling party to press one or more predefined keys on the dialpad of the telephone 112 if the calling party wants to connect to the target communication device, which is now available to receive a VoIP call from the communication device 102A. Next, at block 1134, a determination is made by the automatic notification module 110 whether the calling party wants to make the connection, i.e., a VoIP call, to the target communication device. When the predefined keys are pressed by the calling party in response to the option, the DTMF receiver 248 of the call routing device 114 decodes the DTMF signals generated by the telephone 112 and the decoded signals are transmitted to the microcontroller 250. The microcontroller 250 then transmits an appropriate signal to the automatic notification module 110, which allows the automatic notification module to determine whether the calling party desires to connect to the target communication device.

If the calling party indicates that the calling party does not want to connect to the target communication device, then the process proceeds to block 1138. However, if the calling party indicates that the calling party does want to connect to the target communication device, then the process proceeds to block 1136, where the procedure for making a VoIP call is automatically performed by the automatic otification device 110. Similar to block 1106 of FIG. 11A, the procedure form making a VoIP call corresponds a portion of the flow diagram of FIG. 8 from block 814 to the end. Next, at block 1138, the monitoring of the target communication device is removed. Thus, the monitoring of the target communication device is terminated. However, other communication devices may continue to be monitored by the automatic notification module 110 until the monitoring of those communication device are removed. Next, at block 1140, the communication request is terminated.

The automatic notification feature of the communication device 102A allows a user of the communication device 102A to know when a target communication device is available to receive a VoIP call so that the user does not have to waste time attempting to make a call to the target communication device when the target communication device is not available to receive a call. Although the automatic notification feature has been described in the context of VoIP calls made within the telecommunications system 100, the automatic notification feature can also be applied to a cellular telecommunication system.

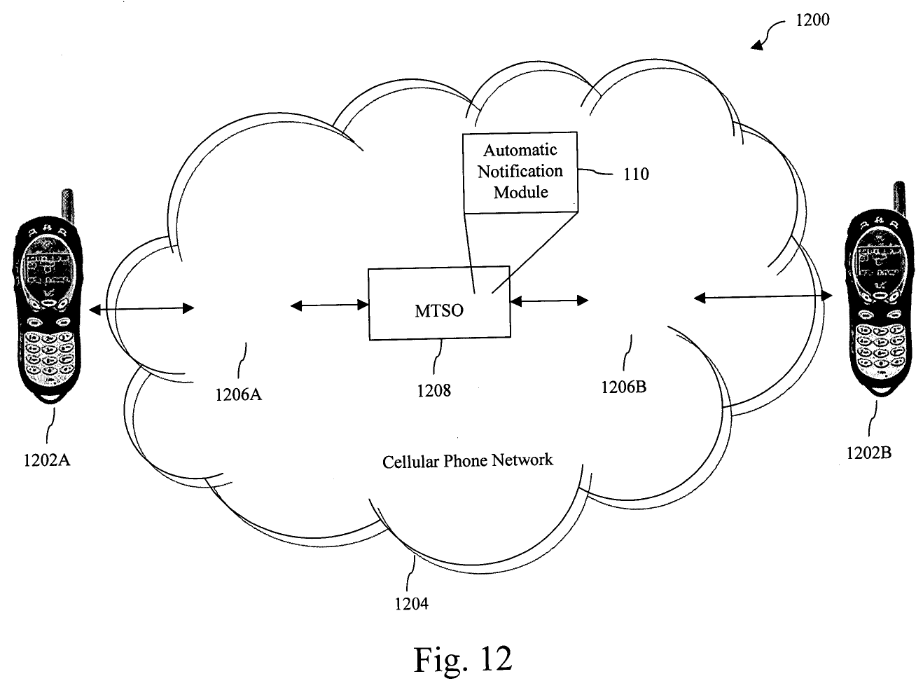

Turning now to FIG. 12, a cellular telecommunications system 1200 that provides an automatic notification feature in accordance with an embodiment of the invention is shown. The cellular telecommunications system 1200 includes cellular phones 1202A and 1202B and a cellular phone network 1204. Although only two cellular phones 1202A and 1202B are shown, the cellular telecommunication system 1200 may include more cellular phones. The cellular phone network 1204 includes base stations 1206A and 1206B and mobile telephone switching offices (MTSOS) 1208. In order to simplify the figure, the cellular phone network is shown in FIG. 12 as having only two base stations 1206A and 1206B and a single MTSO 1208. However, the actual cellular phone network 1204 includes numerous base stations and MTSOs. In this illustrated embodiment, the MTSO 1208 includes the automatic notification module 110 to provide the automatic notification feature to one or more cellular phones, e.g., the cellular phones 1202A and 1202B, of the cellular telecommunications system 1200. In another embodiment, the automatic notification module 110 is included in one or more cellular phones of the cellular telecommunications system 1200 to provide the automatic notification feature only to those cellular phones that have the automatic notification module.

If the automatic notification module 110 is included in one or both cellular phones 1202A and 1202B, then the automatic notification module would operate in a similar manner as described above with respect to the telecommunications system 100 to provide a notification of availability of a target cellular phone to establish a cellular phone call. Since the cellular phone network 1204 knows when each cellular phone has been activated and “logged on” to the cellular phone network, the automatic notification module 110 can request this status information from the cellular phone network 1204 to monitor one or more target cellular phones to determine when those cellular phones are available to receive cellular phone calls. When a target cellular phone becomes available, the automatic notification module 110 can automatically dial the available cellular phone to connect the calling cellular phone to the target cellular phone.

If the automatic notification module 110 is included in the MTSO 1208, then the automatic notification module would operate in a similar manner as the automatic notification module in a cellular phone, except the automatic notification module would have to transmit a signal to the calling cellular phone that requested a target cellular phone to be monitored to notify the calling cellular phone when the target cellular phone becomes available to receive a cellular phone call. This may involve making a phone call to the calling cellular phone. Furthermore, after the notification, the automatic notification module 110 may automatically dial the available cellular phone in response to a command entered into the calling cellular phone and connect the phone call to the calling cellular phone and the phone call to the available cellular phone to establish a call between the calling cellular phone call and the target cellular phone.

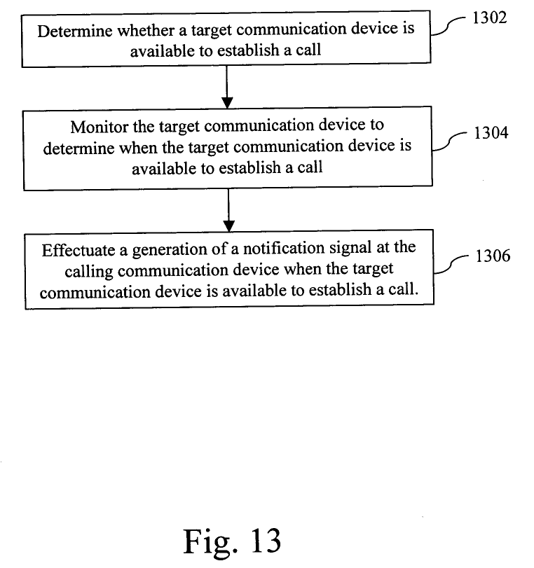

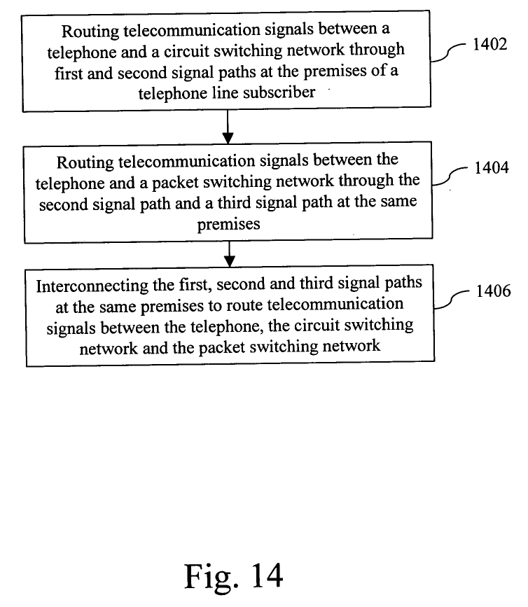

A method for providing a notification of an availability of a target communication device to establish a call in accordance with an embodiment of the invention is described with reference to a flow diagram of FIG. 13. The communication device may be a cellular phone. At block 1302, a determination is made whether the target communication device is available to establish a call. Next, at block 1304, the target communication device is monitored to determine when the target communication device is available to establish a call. Next, at block 1306, a generation of a notification signal is effectuated at the calling communication device when the target communication device is available to establish a call.

Although specific embodiments of the invention have been described and illustrated, the invention is not to be limited to the specific forms or arrangements of parts so described and illustrated. The scope of the invention is to be defined by the claims appended hereto and their equivalents.

1. A method for providing a notification of an availability of a target communication device to establish a call comprising:
determining whether said target communication device is available to establish a call;
monitoring said target communication device to determine when said target communication device is available to establish a call; and
effectuating a generation of a notification signal at said calling communication device when said target communication device is available to establish a call.

2. The method of claim 1 wherein said determining is executed in response to a request from said calling communication device to establish a new call with said target communication device.

3. The method of claim 1 wherein said determining includes determining whether said target communication device is logged on to a network that enables telephone calls to be established between said calling communication device and said target communication device.

4. The method of claim 3 wherein network includes an instant messaging network that enables Voice over Internet Protocol calls through a packet switching network.

5. The method of claim 3 wherein network includes a cellular telephone network.

6. The method of claim 3 wherein said monitoring includes repeatedly receiving status information of said target communication device from said network.

7. The method of claim 1 wherein said monitoring is executed in response to a predefined dual tone multi-frequency signal generated at said calling communication device.

8. The method of claim 1 wherein said generating includes activating a ring signal generator to transmit a ring signal to a telephone of said calling communication device so that an audio notification signal is generated by said telephone.

9. The method of claim 1 further comprising automatically initiating a new call to said target communication device to establish said new call between said calling communication device and said target communication device when said target communication device is available to establish a call.

10. A telecommunications system comprising:
a calling communication device operatively connected to a network to transmit and receive signals through said network; and
an automatic notification module operatively connected to said network to monitor a target communication devices operatively connected to said network to determine when said target communication device is available to establish a call, said automatic notification module being configured to effectuate generation of a notification signal at said calling communication device when said target communication device is available to establish a call.

11. The telecommunication system of claim 10 wherein said automatic notification module is configured to determine when said target communication device is available to establish a call in response to a request from said calling communication device to establish a new call with said target communication device.

12. The telecommunications system of claim 10 wherein said automatic notification module is configured to determine whether said target communication device is logged on to said network to determine when said target communication device is available to establish a call.

13. The telecommunications system of claim 10 wherein network includes an instant messaging network that enables Voice over Internet Protocol calls through a packet switching network.

14. The telecommunications system of claim 10 wherein network includes a cellular telephone network.

15. The telecommunications system of claim 10 wherein said automatic notification module is configured to repeatedly receive status information of said target communication device from said network.

16. The telecommunications system of claim 10 wherein said automatic notification module is configured to monitor said target communication device in response to a predefined dual tone multi-frequency signal generated at said calling communication device.

17. The telecommunications system of claim 10 wherein said automatic notification module is configured to activate a ring signal generator to transmit a ring signal to a telephone of said calling communication device so that an audio notification signal is generated by said telephone.

18. The telecommunications system of claim 10 wherein said automatic notification module is configured to automatically initiate a new call to said target communication device to establish said new call between said calling communication device and said target communication device.

19. A program storage medium readable by a computer, tangibly embodying a program of instructions executable by said computer to perform method steps for providing a notification of an availability of a target communication device to establish a call, said method steps comprising:
determining whether said target communication device is available to establish a call;
monitoring said target communication device to determine when said target communication device is available to establish a call; and
effectuating generation of a notification signal at said calling communication device when said target communication device is available to establish a call.

20. The program storage medium of claim 19 wherein said determining is executed in response to a request from said calling communication device to establish a new call with said target communication device.

21. The program storage medium of claim 19 wherein said determining includes determining whether said target communication device is logged on to a network that enables telephone calls to be established between said calling communication device and said target communication device.

22. The program storage medium of claim 21 wherein network includes an instant messaging network that enables Voice over Internet Protocol calls through a packet switching network.

23. The program storage medium of claim 21 wherein network includes a cellular telephone network.

24. The program storage medium of claim 21 wherein said monitoring includes repeatedly receiving status information of said target communication device from said network.

25. The program storage medium of claim 19 wherein said monitoring is executed in response to a predefined dual tone multi-frequency signal generated at said calling communication device.

26. The program storage medium of claim 19 wherein said generating includes activating a ring signal generator to transmit a ring signal to a telephone of said calling communication device so that an audio notification signal is generated by said telephone.

27. The program storage medium of claim 19 wherein said method steps further comprises automatically initiating a new call to said target communication device to establish said new call between said calling communication device and said target communication device when said target communication device is available to establish a call.
